(19) United States
(12) Patent Application Publication
(10) Pub. No.: US 2011/0180577 A1
(43) Pub. Date: Jul. 28, 2011

(54) DEVICE FOR FACILITATING THE USE OF REUSABLE SHOPPING BAGS

(76) Inventor: SUSAN ELIZABETH WOODWARD, Stow, OH (US)

(21) Appl. No.: 12/692,619

(22) Filed: Jan. 24, 2010

(51) Int. Cl. B60R 9/00; B60R 11/00

(52) U.S. Cl. 224/411; 224/5

(57) ABSTRACT

A device for facilitating the use and transport of reusable shopping bags has a pair of straps that extend around and secure one of more reusable bags. The straps are securable to one another at a number of locations so the straps can secure a variable number of reusable shopping bags. The device is provided with a snap hook or another fastener for fastening the device to a shopping cart or shopping basket.

### FIELD OF THE INVENTION

The present invention relates to a device that makes the storage and transport of reusable shopping bags more convenient.

### BACKGROUND OF THE INVENTION

As the general population has become more aware of ecological issues many persons have sought ways to reduce the volume of waste that accumulates in waste disposal facilities such as landfills. Significant sources of waste are product packaging and paper and plastic bags used for transporting shopper products from retail stores to shopper's homes or other destinations. While some paper and plastic bags are collected for recycling, many are not and instead enter the stream of items destined for waste disposal facilities such as landfills.

Many retail stores have started to sell reusable shopping bags made or cloth or polymeric materials. Widespread use of reusable shopping bags could significantly reduce the volume of paper and plastic shopping bags that shoppers generally consider to be disposable and often enter the stream of waste going to landfills. Many well intentioned shoppers purchase reusable shopping bags, but fail to reuse them on a regular basis due to simply forgetting to take the reusable shopping bags to a store, or the inconvenience of transporting a plurality of reusable shopping bags. It is further inconvenient to handle the reusable shopping bags in a store because at the beginning of a shopping session they are placed in the bottom of a shopping cart or shopping basket causing them to not be readily accessible at the check-out until all the items selected for purchase and placed on top of the reusable shopping bags have been removed from the shopping cart or basket. It is not convenient for a shopper to carry a plurality of loose reusable shopping bags by hand because the shopper needs his or her hands free for the handling of products contemplated for purchase and placing selected products in a shopping cart or basket.

### SUMMARY OF THE INVENTION

The present invention provides a device that allows a shopper to conveniently organize and transport a plurality of reusable shopping bags and attachment of the device to a shopping cart or basket. The device has a bag securing portion and an attachment portion for attaching the device to a shopping cart or basket. The bag securing portion is adaptable to secure a varying number of reusable shopping bags to the device. The device may be attached to the exterior or interior of a shopping cart or basket such that the reusable shopping bags will be readily accessible at the start of the check-out process. In some embodiments of the device the attachment portion may provide a loop that functions as a handle during transport of the device and the associated reusable shopping bags from a parking lot to the retail facility.

### BRIEF DESCRIPTION OF THE DRAWINGS

FIG. 1 is a perspective view of a first embodiment of the device without any reusable shopping bags being secured by the device and the loop forming member hanging freely.

FIG. 2 is a side view of the first embodiment of the device without any reusable shopping bags being secured by the device and the loop forming member disposed in a loop forming configuration.

FIG. 3 is a first side view of a second embodiment of the device without any reusable shopping bags being secured by the device and the loop forming members hanging freely.

FIG. 4 is another side view of second embodiment of the device without any reusable shopping bags being secured by the device and the loop forming members disposed in a loop forming configuration.

FIG. 5 is yet another side view of second embodiment of the device without any reusable shopping bags being secured by the device and the loop forming members hanging freely.

FIG. 6 is a first snap hook that may be a component of the device.

FIG. 7 is a second snap hook that may be a component of the device.

FIG. 8 is a third snap hook that may be a component of the device.

FIG. 9 is a D ring that may be a component of the device.

FIG. 10 shows two lengths of strap that may be used as components of a third embodiment of the device.

FIG. 11 shows two components of a buckle that may be a component of the device.

FIG. 12 shows another buckle configuration that may be a component of the device.

FIG. 13 shows yet another buckle configuration that may be a component of the device.

FIG. 14 shows another means of fixing two straps to one another wherein one strap is provided with magnetic buttons and the other strap is provided with ferrous buttons.

FIG. 15 shows yet another means of fixing two straps to one another wherein each of the straps has a plurality of holes in it and a snap hook extends through aligned holes to secure the straps together.

FIG. 16 shows still another means of fixing two strap to one another using a clamp.

FIGS. 17 and 18 show a device according to the first embodiment of FIGS. 1 and 2 securing a plurality of reusable shopping bags.

FIGS. 19 and 20 show a device according to the second embodiment of FIGS. 3-5 securing a plurality of reusable shopping bags.

### DETAILED DESCRIPTION OF THE INVENTION

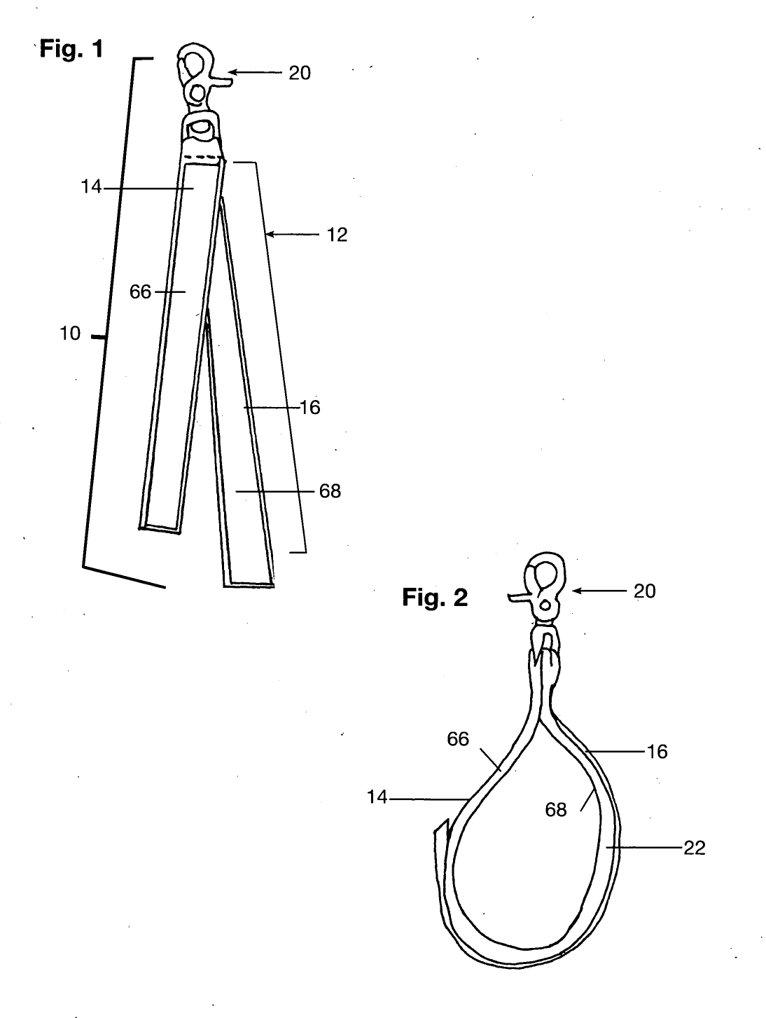

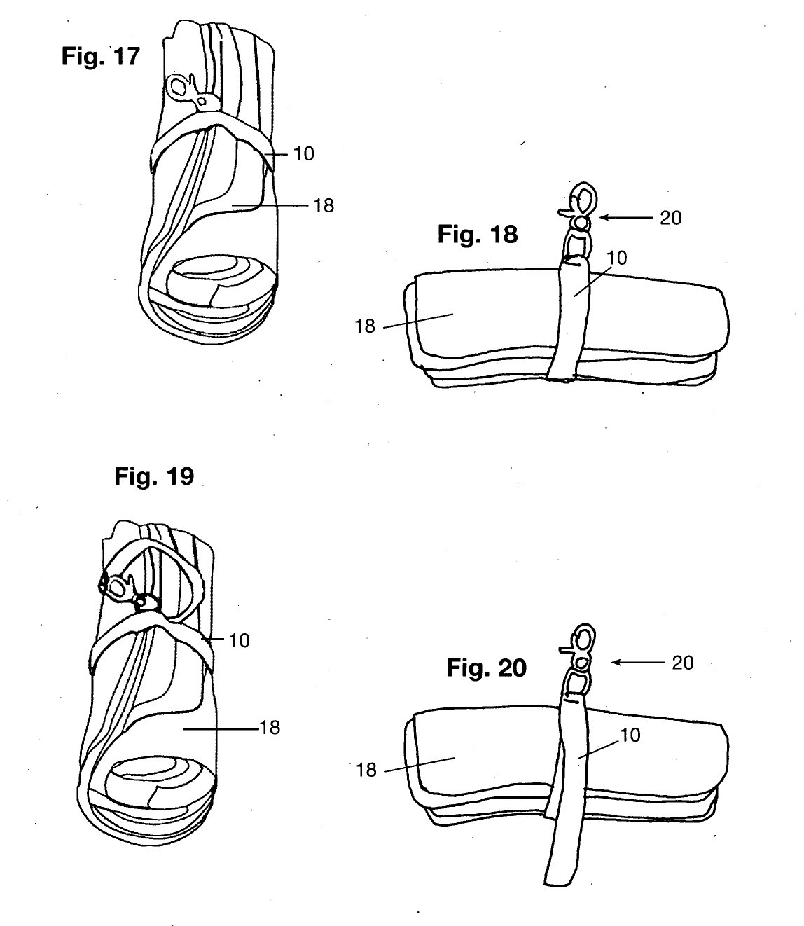

Referring first to FIGS. 1 and 2 a device 10 for facilitating the use of reusable shopping bags has a bag securing portion 12 comprising a pair of elongate members 14, 16 for placement around one or more reusable shopping bags. As used herein and in the claims an elongate member is understood to mean a member having notably more length than width. Preferably the elongate members are straps made of natural or synthetic fibers, for example nylon or polyester. As used herein and in the claims the term “strap” is understood to have its' common meaning of a long narrow strip of a pliant material. The elongate members are provided with a means for fastening the elongate members to one another at a plurality of locations to secure one or more reusable shopping bags between the elongate members such that the bag securing portion accommodates a variable number of reusable shopping bags 18 as shown in FIGS. 17-20.

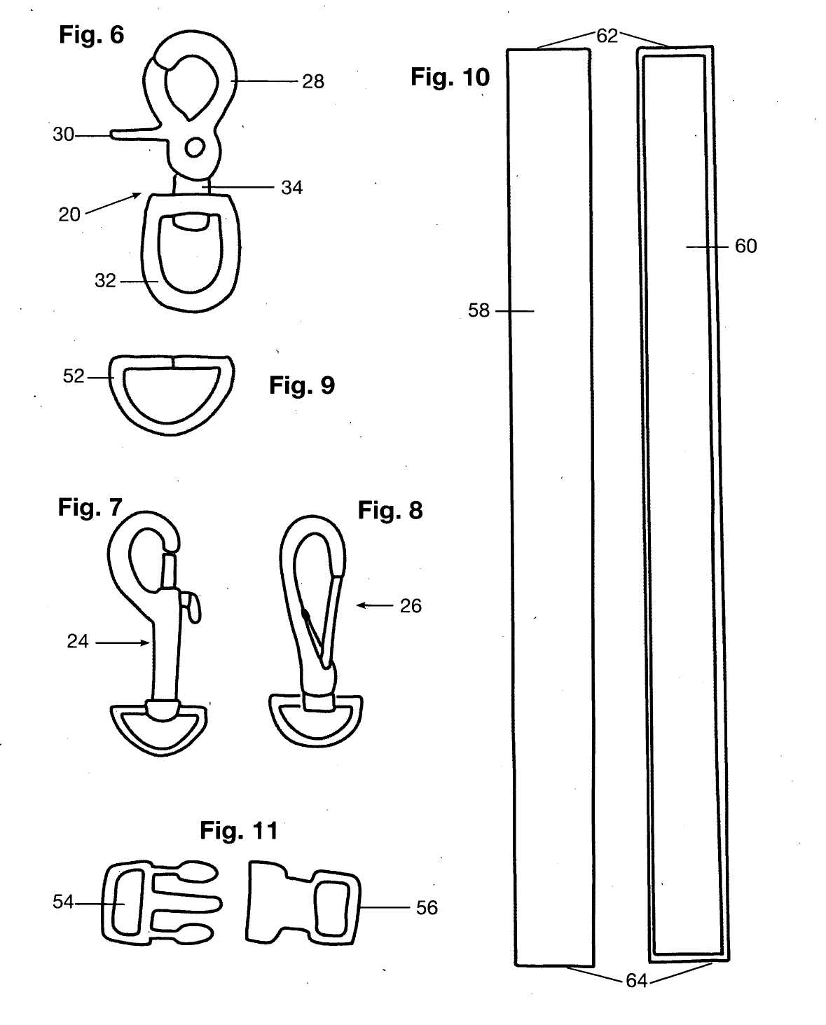

Fixed to the bag securing portion 12 of the device is a means 20 for attaching the device to a shopping cart or a shopping basket. The junction of the first and second elongate members 14, 16 is preferably a closed loop 22 used for the fixing to the bag securing portion the means for attaching the device to a shopping cart or a shopping basket. In the first embodiment the means for attaching the device to a shopping cart or a shopping basket is a snap hook 20. A snap hook 20 used in a prototype device is shown in FIG. 6. Examples of alternative snap hooks 24, 26 that may be used in the practice of the present invention are shown in FIGS. 7 and 8. A snap-hook has a hook 28, forming a portion of an eye loop, and a lever 30 that is pivotally or linearly movable relative to the hook. The lever forms a remaining portion of said eye loop with respect to the hook. The lever is pivoted or depressed by pushing either directly on the lever or on a thumb tab to open the eye loop allowing the hook to pass through or around a member and then the thumb tab is released and the loop is closed. A snap hook used in the practice of the present invention is connected to a closed ring 32, such as a D ring, using a pin 34 that allows the snap hook to rotate. The loop 22 provided by the bag securing portion passes through the closed ring fixed of the snap hook to secure the snap hook to the bag securing portion. The snap hook is used to attach the device to a shopping cart or shopping basket having a typical wire construction. Further, the snap hook may be used for securing the device to a hook on a wall or in a vehicle for storage or transport of reusable shopping bags secured to the device.

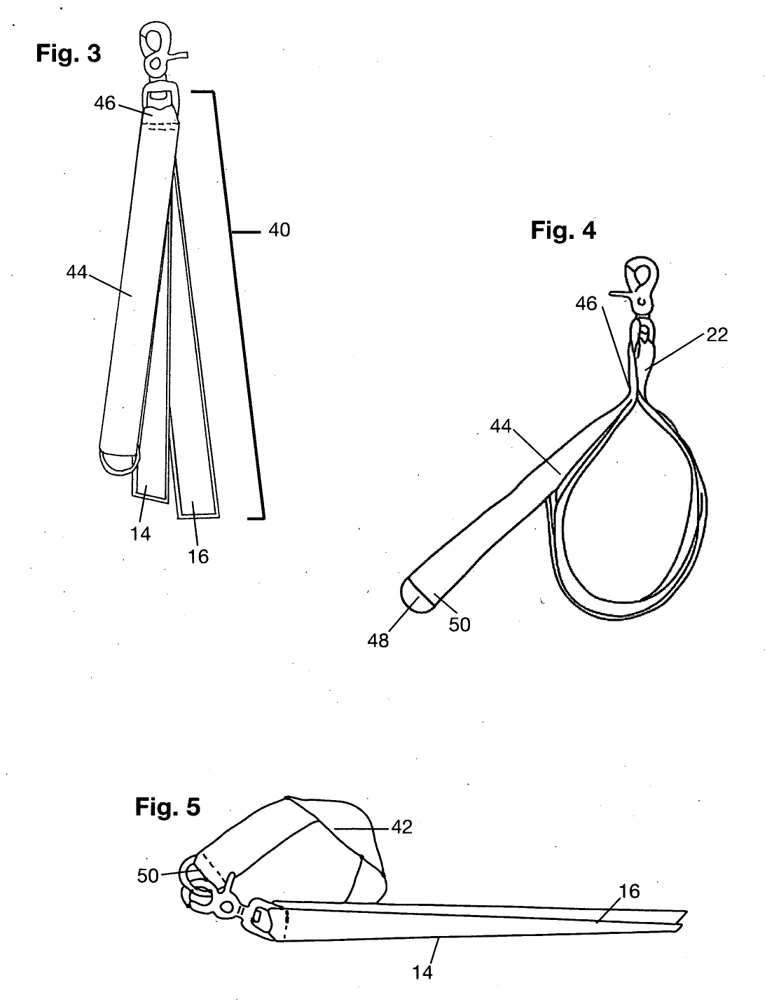

While the first embodiment described above function very well, a shopper may find it convenient to have a handle for carrying the device when it is securing a plurality of reusable shopping bag. Referring next to FIGS. 3-5 there is shown a second embodiment 40 of the device that is provided with such a handle 42. Again this embodiment has a pair of straps members 14, 16 for placement around one or more reusable shopping bags. The strap members are provided with a means for fastening the strap members to one another at a plurality of locations to secure one or more reusable shopping bags between the strap members such that the securing portion accommodates a variable number of reusable shopping bags. The two strap members of the securing portion comprise a single strap that is folded over upon itself to provide two layers, each layer having a free end and a fold end. The two layers are attached to one near the fold end to provide a closed loop 22 at the fold end, each of the layers being a strap member 14, 16.

A means for attaching the device to a shopping cart or shopping basket includes a closed ring 32, the loop 22 provided at the fold end of the bag securing portion passing through the closed ring of the means for attaching the device to a shopping cart or shopping basket to secure the closed ring to the bag securing portion. Preferably the closed ring is a component of a snap hook 20, 24, 26 as described above. An elongate member, preferably a length of strap 44, has first and second ends, the first end 46 of being fixed to the bag securing portion and the second end 48 forming a closed loop 50 that passes through a closed ring 52, the closed ring being attachable to the snap-hook. The closed ring may be for example a D ring 52 as shown in FIG. 9. The length of strap may be fixed to a strap member of the bag securing portion of the device by stitching or adhesive or any other suitable means. Then the closed ring 52 is secured to the snap hook 20, the length of strap 44 may function as a carrying handle. In a situation where a shopping cart or shopping basket is not of a wire construction, the length of strap may pass around a handle or through a suitable opening in a shopping cart or shopping basket and then the closed ring is fastened to the snap hook to secure the device and the secured reusable shopping bags to the shopping cart or shopping basket. It follows that the carrying handle or closed ring may further find use in the storage or transport of the device and secured reusable shopping bags.

With reference to FIG. 11 an alternate means for providing the carrying handle is that the closed ring secured to the length of strap 44 is a part of a first part 54 of a widely used buckle mechanism thereby securing the first part of the buckle mechanism to the length of strap. Instead of a snap hook the closed loop provided by the bag securing portion passes through a closed ring that is a part of a second part 56 of the buckle mechanism thereby securing the second part of the buckle mechanism to the bag securing portion of the device. The first and second parts 54, 56 of the buckle mechanism are attachable to one another in a removable manner.

With reference to FIG. 10 there is shown separate lengths of strap 58, 60. Another embodiment of the invention may be manufactured wherein the bag securing portion comprises two elongate members, preferably straps, that each have first and second ends 62, 64. The first ends 62 of the elongate members are secured to one another, and the elongate members are further joined together a short distance from their first ends to provide a loop, the means for attaching the device to a shopping cart or a shopping basket being secured to the device using said loop.

An important feature of all of the embodiments of the device of the present invention is that the elongate members, preferably straps 14, 16, are provided with a means for fastening the elongate members to one another at a plurality of locations to secure one or more reusable shopping bags between the elongate members such that the bag securing portion accommodates a variable number of reusable shopping bags. Preferably, as shown in FIGS. 1-5, the means for fastening the strap members to one another at a plurality of locations is a hook and loop fastening system. One of the strap members 14 has secured thereto a length of a hook tape 66 and the other strap member 16 has secured thereto a length of a loop tape 68. An example of a hook and loop fastening system is marketed under the trademark Velcro® The hook tape presents a rough or hard side for mating with the loop tape that presents a soft or fuzzy side. The hook and loop tapes may be secured to the straps by sewing, adhesive or any other suitable means.

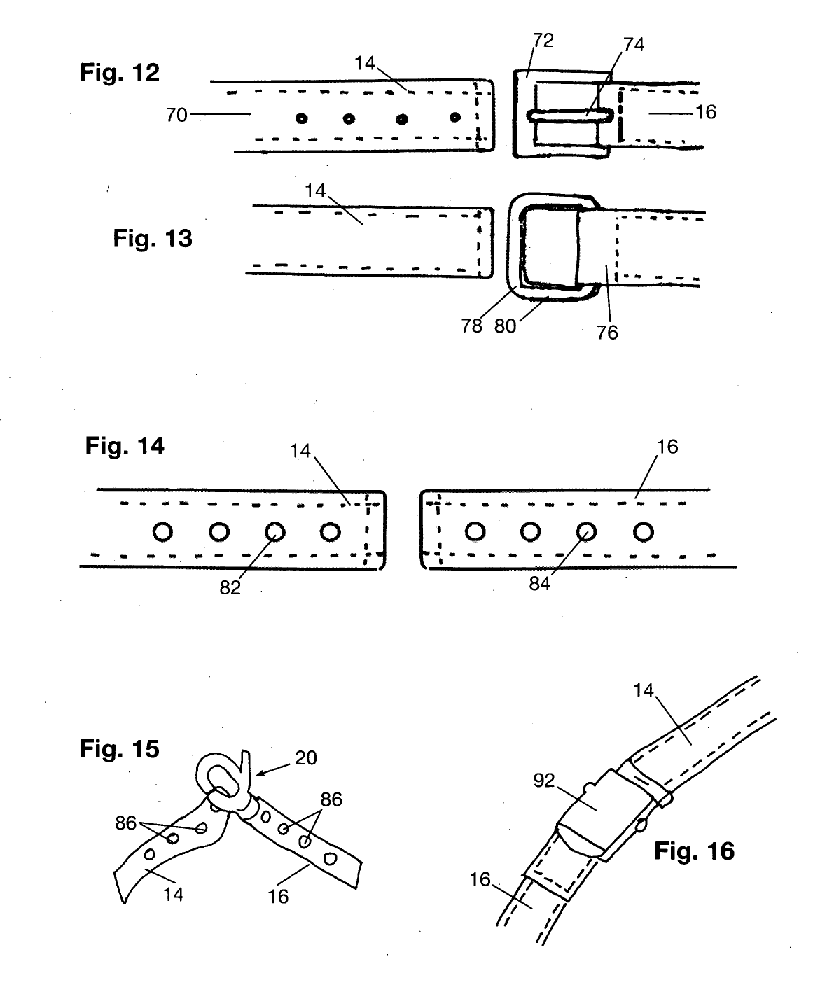

With reference to FIG. 12 an alternative means of fastening the elongate members to one another at a plurality of locations comprises one of the strap members 14 is provided with a plurality of longitudinally spaced apart holes 70 therethrough and the other strap member 16 is provided with a belt buckle 72 having a clasp 74 that can pivot and is insertable through any one of the holes 70 in the other strap member 14.

With reference to FIG. 13 another alternative means of fastening the elongate members to one another at a plurality of locations comprises one of the strap members 16 having a free end thereof folded over and fastened to the strap member to form a loop 76, the loop passing through two closed rings 78, 80, the other strap member 14 being passed through the two rings in a circuitous path to secure the strap members to one another.

With reference to FIG. 14 another alternative means of fastening the elongate members to one another at a plurality of locations comprises a plurality of longitudinally spaced magnetic buttons 82 fixed to one of the strap members 16. The other strap member 14 has a plurality of longitudinally spaced apart ferrous buttons 84 fixed thereto. At least one of the magnetic button is magnetically attached to one of the ferrous buttons to fasten the two strap members to one another.

With reference to FIG. 15 another alternative means of fastening the elongate members to one another at a plurality of locations comprises a plurality of longitudinally spaced holes 86 through each of the strap members 14, 16 and a snap hook 20 that can pass through aligned holes of the strap members to fasten the two strap members to one another.

With reference to FIG. 16 another alternative means of fastening the elongate members to one another at a plurality of locations comprises a clamp 90 that has passages therein for receiving each of the strap members 14, 16, at least one of the strap members being movable through a passage in the clamp such that the a jaw 92 of the clamp may be tightened to secure the strap members to one another at a plurality of locations with respect to the strap members.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. A device for facilitating the use of reusable shopping bags comprising: a bag securing portion comprising a pair of elongate members for placement around one or more reusable shopping bags, the elongate members are provided with a means for fastening the elongate members to one another at a plurality of locations to secure one or more reusable shopping bags between the elongate members such that the bag securing portion accommodates a variable number of reusable shopping bags; and fixed to the bag securing portion is a means for attaching the device to a shopping cart or a shopping basket.

2. The device according to claim 1 wherein the elongate members of the bag securing portion comprise two elongate members that each have first and second ends, the first ends of the elongate members are secured to one another, and the elongate members are further joined together a short distance from their first ends to provide a loop, the means for attaching the device to a shopping cart or a shopping basket being secured to the device using said loop.

3. A device for facilitating the use of reusable shopping bags comprising: a bag securing portion comprising a pair of straps members for placement around one or more reusable shopping bags, the strap members provided with a means for fastening the strap members to one another at a plurality of locations to secure one or more reusable shopping bags between the strap members such that the securing portion accommodates a variable number of reusable shopping bags; and fixed to the securing portion is a means for attaching the device to a shopping cart or a shopping basket.

4. The device according to claim 3 wherein the two strap members of the securing portion comprise a single strap that is folded over upon itself to provide two layers, each layer having a free end and a fold end, the two layers being attached to one near the fold end to provide a closed loop at the fold end, each of the layers being a strap member.

5. The device according to claim 4 wherein the means for attaching the device to a shopping cart or shopping basket includes a closed ring, the loop provided at the fold end of the bag securing portion passing through the closed ring of the means for attaching the device to a shopping cart or shopping basket to secure the closed ring to the bag securing portion.

6. The device according to claim 4 wherein the means for attaching the device to a shopping cart or shopping basket consists of a snap-hook, the snap hook including a closed ring, the loop provided at the fold end of the bag securing portion passing through the closed ring to secure the snap hook to the bag securing portion.

7. The device according to claim 3 wherein the means for attaching the device to a shopping cart or shopping basket comprises a snap-hook, the snap hook including a closed ring, the loop provided at the fold end of the bag securing portion passing through the closed ring to secure the snap hook to the bag securing portion.

8. The device according to claim 7 wherein the means for attaching the device to a shopping cart or shopping basket further comprises an elongate member having first and second ends, the first end of the elongate member being fixed to the bag securing portion and the second end of the elongate member forming a closed loop that passes through a closed ring, the closed ring being attachable to the snap-hook.

9. The device according to claim 7 wherein the means for attaching the device to a shopping cart or shopping basket further comprises a length of strap having first and second ends, the first end of the length of strap being fixed to the bag securing portion and the second end of the length of strap forming a closed loop that passes through a closed ring, the closed ring being attachable to the snap-hook.

10. The device according to claim 4 wherein the means for attaching the device to a shopping cart or shopping basket further comprises a length of strap having first and second ends, the first end of the length of strap being fixed to the bag securing portion and the second end of the length of strap forming a closed loop that passes through a closed ring that is a part of a first part of a buckle mechanism thereby securing the first part of the buckle mechanism to the length of strap; the closed loop at the fold end of the bag securing portion passing through a closed ring that is a part of a second part of the buckle mechanism thereby securing the second part of the buckle mechanism to the bag securing portion of the device, the first and second parts of the buckle mechanism being attachable to one another in a removable manner.

11. The device according to claim 3 wherein the means for fastening the strap members to one another at a plurality of locations comprises a hook and loop fastening system, one of the strap members having secured thereto a length of a hook tape and the other strap member having secured thereto a length of a loop tape.

12. The device according to claim 4 wherein the means for fastening the strap members to one another at a plurality of locations comprises a hook and loop fastening system, one of the strap members having secured thereto a length of a hook tape and the other strap member having secured thereto a length of a loop tape.

13. The device according to claim 9 wherein the means for fastening the strap members to one another at a plurality of locations comprises a hook and loop fastening system, one of the strap members having secured thereto a length of a hook tape and the other strap member having secured thereto a length of a loop tape.

14. The device according to claim 10 wherein the means for fastening the strap members to one another at a plurality of locations comprises a hook and loop fastening system, one of the strap members having secured thereto a length of a hook tape and the other strap member having secured thereto a length of a loop tape.

15. The device according to claim 3 wherein the means for fastening the strap members to one another at a plurality of locations comprises a clamp that has passages therein for receiving each of the strap members, at least one of the strap members being movable through a passage in the clamp such that the a jaw of the clamp may be tightened to secure the strap members to one another at a plurality of locations with respect to the strap members.

16. The device according to claim 3 wherein the means for fastening the strap members to one another at a plurality of locations comprises one of the strap members being provided with a plurality of longitudinally spaced apart holes therethrough and the other strap member being provided with a belt buckle having a clasp that can pivot and is insertable through any one of the holes in the other strap member.

17. The device according to claim 3 wherein the means for fastening the strap members to one another at a plurality of locations comprises a plurality of longitudinally spaced holes through each of the strap members and a snap hook that can pass through aligned holes of the strap members to fasten the two strap members to one another.

18. The device according to claim 3 wherein the means for fastening the strap members to one another at a plurality of locations comprises a plurality of longitudinally spaced magnetic buttons fixed to one of the strap members, the other strap member having a plurality of longitudinally spaced apart ferrous buttons fixed thereto, at least one of the magnetic button being magnetically attached to one of the ferrous buttons to fasten the two strap members to one another.

19. The device according to claim 3 wherein the means for fastening the strap members to one another at a plurality of locations comprises one of the strap members having a free end thereof folded over and fastened to the strap member to form a loop, the loop passing through two closed rings, the other strap member being passed through the two rings in a circuitous path to secure the strap members to one another.

20. A device for facilitating the use of reusable shopping bags comprising: a bag securing portion comprising a single strap that is folded over upon itself to provide two layers, each layer having a free end and a fold end, the two layers being attached to one another near the fold end to provide a closed loop at the fold end, each of the layers being a strap member, one of the strap members having secured thereto a length of a hook tape and the other strap member having secured thereto a length of a loop tape to provide a means for fastening the strap members to one another at a plurality of locations such that the bag securing portion accommodates a variable number of reusable shopping bags; fixed to the securing portion is a means for attaching the device to shopping cart or a shopping basket, the means for attaching the device to a shopping cart or shopping basket comprising a snap-hook, the snap hook including a closed ring, the loop provided at the fold end of the bag securing portion passing through the closed ring to secure the snap hook to the bag securing portion; a length of strap having first and second ends, the first end of the length of strap being fixed to the bag securing portion and the second end of the length of strap forming a closed loop that passes through a closed ring, the closed ring being attachable to the snap-hook.
